(19) United States
(12) Patent Application Publication
(10) Pub. No.: US 2026/0330764 A1
(43) Pub. Date: Oct. 22, 2026

(54) Georeferenced Synthetic Environment Generation System

(71) Applicant: SynPlanet Holding Corporation, Newark, DE (US)

(72) Inventor: Andrey Kirsanov, Hamilton South (AU)

(21) Appl. No.: 19/452,598

(22) Filed: Jan. 19, 2026

Related U.S. Application Data
(60) Provisional application No. 63/747,320, filed on Jan. 20, 2025.

(51) Int. Cl. G06T 17/05; G01S 17/89; G06V 10/764

(52) U.S. Cl. CPC G06T 17/05; G01S 17/89; G06V 10/764

(57) ABSTRACT

Techniques are disclosed for procedurally generating georeferenced synthetic environments either by a standalone system or by a plugin to an existing gaming or simulation engine. For this purpose, geographic information system (GIS) data is first ingested and stored in a database. A machine learning (ML) classification model pretrained using computer vision for identifying objects is then use to classify land objects into categories of classified objects. A text-to-image model is prompted by the user and/or the system to generate additional or augmented content to be overlaid onto the synthetic environment. Based on the GIS data, the classified objects and the above augmented content, a rendering pipeline produces a set of visualization assets that are then used to render the georeferenced synthetic environment on a computer display.

### RELATED APPLICATIONS

This application claims priority from U.S. Provisional Patent Application No. 63/747,320 filed on Jan. 20, 2025 and which is incorporated by reference herein for all purposes in its entirety.

### FIELD OF THE INVENTION

This invention relates generally to Geographic Information Systems (GIS) and more specifically to the generation of georeferenced synthetic environments.

### BACKGROUND ART

Geographic Information Systems (GIS) are used for capturing, analyzing, and visualizing spatial data to understand relationships, patterns, and trends in the real world. These systems integrate multiple types of maps, satellite imagery, and tabular information and enable users to overlay, analyze, and derive geographic insights about the data. GIS has applications in various fields, including urban planning, environmental management, public health, and disaster response. By combining spatial data with analytical capabilities, GIS empowers users to address complex problems, such as urban planning, optimizing transportation networks, monitoring deforestation, planning emergency evacuations, among others.

Useful applications of GIS systems involve georeferenced data that aligns spatial data to a known coordinate system for providing accurate representations of locations on Earth. Georeferencing involves associating datasets like scanned maps, aerial photographs, or field observations with geographic coordinates, enabling integration with other spatial layers. Georeferenced data allows users to compare and contrast datasets from different sources, conduct precise measurements, create meaningful visualizations and perform spatial and geographic analysis.

Various GIS systems also utilize terrain rendering. Terrain rendering is the process of visually representing the surface of the Earth or a simulated environment in a 3D space for applications including video games, virtual environments generation and simulation. Most common terrain rendering is the depiction of the surface of the Earth. It is used in various applications to give an observer a frame of reference. It is also often used in combination with rendering of non-terrain objects, such as trees, bushes, buildings, rivers, and the like. A typical terrain rendering system includes a terrain database, a central processing unit (CPU), a dedicated graphics processing unit (GPU) and a display.

There is a plethora of prior art for rendering synthetic environments based on GIS data. U.S. Pat. No. 8,976,169 Bl to Barreirinhas et al. discloses systems, methods, and computer storage mediums for blending custom terrain patches onto a terrain of a virtual three-dimensional (3D) environment. Their method includes accessing terrain data that describes a mesh representing the surface of the terrain of the 3D environment. The mesh is constructed of primitives that are defined by a terrain altitude at each vertex. A surface grid is determined from the primitives such that each point in the surface grid includes the terrain altitude where the point falls on the mesh. Custom terrain data is also accessed that includes a custom grid of terrain altitudes. A patch grid is determined from the custom grid such that each point in the patch grid includes a terrain altitude derived from the custom grid. The patch and surface grids are blended such that each terrain altitude in the patch grid modifies its corresponding terrain altitude in the surface grid.

U.S. Pat. No. 6,229,546 Bl to Lancaster et al. describes a method and system for generating a 3D world model for simulated real terrain optimized for a personal computer. Terrain data and other environmental data are acquired from at least one of a plurality of digital data sources through an acquisition step and the acquired data are processed in a transformation and formatting step. This is done in order to construct a predetermined intermediate database format that is introduced through a query interface program that is visible on a personal computer monitor. The data are further extracted, processed and composited in a formatting step to create a 3D world model file.

U.S. Patent Publication No. 2008/0310733 Al to Adabala teaches a facade rendering system. In various embodiments, the facade rendering system identifies horizontal waveforms and vertical waveforms from an image of a structure, combines the identified horizontal and vertical waveforms to generate facade waveforms that model a facade of the structure, and renders the facade waveforms as a facade for the structure. The facade rendering system can include or employ information about the structure from which to create waveform information, waveform information to create a facade waveform for modeling the structure, and a component that renders the structure based on the waveform information.

U.S. Patent Publication No. 2014/0028676 Al to Praun et al. describes a system that receives terrain data representing earth features for a geographic area. The following meshes are generated based on the terrain data: (i) a water surface mesh including a first plurality of geometric primitives and (ii) a water bottom mesh including a second plurality of geometric primitives. Portions of the water bottom mesh appearing above the water surface mesh are identified. At least one of the water surface mesh and the water bottom mesh are corrected to cause the water surface mesh to appear above the water bottom mesh.

U.S. Patent Publication No. 2015/0146940 Al to Ghyme et al. teaches a method of generating implicit terrain data and an electronic apparatus for performing the method. More particularly, it teaches a method of generating implicit terrain data and an electronic apparatus which are capable of minimizing a size of data while maintaining geographical quality of original terrain data.

U.S. Patent Publication No. 2017/0116780 Al to Han et al. discloses a method for rendering a multi-resolution terrain using GPU tessellation. A method for rendering a terrain using GPU tessellation according to an embodiment of the present invention may include: generating a quad patch to which an inner tessellation factor and an edge tessellation factor are allocated by using a quadtree including a parent node and child nodes; generating a base mesh using the quad patch; and restoring a terrain by applying a displacement map to the base mesh.

U.S. Patent Publication No. 2021/0141966 Al to Koch et al. teaches a method and system with the ability to design a terrain surface. A triangular surface mesh representative of an existing surface is obtained. One or more constraints to control the triangular surface mesh are specified. Drainage for the triangular surface mesh is automatically determined based on the constraints. The triangular surface mesh is optimized based on the drainage and one or more design options. The optimizing modifies the triangular surface mesh to define drainage flow for the drainage.

U.S. Patent Publication No. 2021/0327131 Al to Li et al. discloses systems, methods, devices, and non-transitory media of the various embodiments for encoding localized terrain modifications into one or more heightmaps, which are used to modify the vertices of the world-wide terrain map at runtime using a Graphics Processing Unit (GPU). Various embodiments apply displacement to dynamic terrain surfaces, such as time dynamic surfaces, animated surfaces, Hierarchical Level-of-Detail (HLOD) surfaces, and surfaces suitable for interactive user editing, at a global scale.

U.S. Patent Publication No. 2013/0088492 Al to Jagadev et al. discloses portable globes for viewing regions of interest in a Geographical Information System (GIS). A method for providing a portable globe for a GIS may include determining one or more selected regions corresponding to a geographical region of a master globe. The method may further include organizing geospatial data from the master globe based on the selected region and creating the portable globe based on the geospatial data. The portable globe may be smaller in data size than the master globe. The method may include transmitting the portable globe to a local device that may render the selected region at a higher resolution than the remainder of the portable globe in the GIS. A system for providing a portable globe may include a selection module, a fusion module and a transmitter. A system for updating a portable globe may include a packet bundler and a globe cutter.

There are also various GIS systems based on georeferenced data available in the industry. These include Cesium Ion™, Blackshark.ai™, Google Earth™, MAK VR-Forces® and Presagis®.

Despite the abundance of prior art, what is needed in the industry is the ability to procedurally and automatically generate 3D georeferenced synthetic environments. Such a solution, absent from the prior art, would incorporate machine learning (ML) classification models trained on computer vision for classifying non-terrain objects. Such a solution would also utilize text-to-image generation for augmenting the resulting georeferenced synthetic environment. The present invention addresses this industry need.

### OBJECTS OF THE INVENTION

In view of the shortcomings of the prior art, it is an object of the invention to procedurally generate a georeferenced synthetic environment.

It is also an object of the invention to generate the above georeferenced synthetic environment by a standalone system or by a plugin to a game or a simulation engine.

It is further an object of the invention generate the synthetic environment by first ingesting various GIS data.

It is also an object of the invention to classify objects in the imagery data using a machine learning (ML) classification model that is trained using computer vision techniques.

It is further an object of the invention to use a text-to-image generation system for generating geospatial objects to be included in the georeferenced synthetic environment.

It is further an object of the invention to produce visualization assets based on the GIS data, classified objects and the geospatial objects generated by the text-to-image system.

If is also an object of the invention to render the georeferenced synthetic environment based on the visualization assets.

If is further an object of the invention to display the georeferenced synthetic environment on a computer display.

Still other objects and advantages of the invention will become apparent upon reading the summary and the detailed description in conjunction with the drawing figures.

### SUMMARY OF THE INVENTION

The objects and advantages of the invention are achieved by apparatus and methods for procedurally generating georeferenced synthetic environments by a georeferenced synthetic environment generation system or platform. For this purpose, geographic information system (GIS) data is first ingested into the system and stored in a database. The GIS data comprises terrain data, feature data, infrastructure data, land cover data, imagery data and also preferably cadastral data.

While land cover data may already contain objects classified into various categories, the present design also includes an artificial intelligence (AI) and machine learning (ML) module for classifying objects contained in the imagery data. For this purpose, the AI/ML module employs an ML classification model and a computer vision module. The classification model is pretrained based on computer vision for identifying objects in images. Preferably, the computer vision module utilizes the Open Source Computer Vision Library (OpenCV™) library and/or computer software code compatible with the OpenCV library for recognizing objects in the imagery data.

The present technology also employs a text-to-image generation system that is prompted by the user and/or the system itself to generate content to be overlaid or augmented onto the georeferenced synthetic environment being generated. The text-to-image generation system employs a text-to-image generative AI model for generating geospatial visual content or objects to be included into the ultimate georeferenced synthetic environment.

Based on the GIS data ingested into the system, land objects classified by either the instant ML/AI module and/or received in the GIS data, and geospatial objects generated by the text-to-image system, the instant platform produces a set of visualization assets. These visualization assets are used by a rendering engine to generate the desired georeferenced synthetic environment. In one embodiment, the visualization assets are files. Preferably, such visualization files are compatible with the osgEarth™ format.

The synthetic environment is ultimately displayed on a computer display attached to the instant georeferenced synthetic environment generation system. The instant technology can be implemented as a standalone system as discussed above. However, a preferred embodiment implements the technology as a plugin to a game engine. In such a preferred embodiment, the final synthetic environment is rendered by the game engine based on the visualization assets created by the plugin. The instant plugin creates the visualization assets or scene objects based on the GIS data, classified objects and the geospatial objects generated by the text-to-image system.

The synthetic environment generated by the system, whether in its standalone or plugin form, is in response to a user request. Preferably, the user request is submitted in a natural language form. Alternatively, the user selects one or more tiles on a grid, and for which the corresponding synthetic environment is generated. In a preferred embodiment, an avatar is also created in the georeferenced synthetic environment. The avatar performs various tasks in the environment based on prompts submitted by the user.

In the same or a related embodiment, the terrain data comprises elevation data, surface data and Light Detection And Ranging (LiDAR) data. The LiDAR data may be in the form of point clouds.

In the same or a related embodiment, the elevation data has a resolution down to 10 meters. In other words, features 10 meters or bigger are resolvable in the generated synthetic environment.

The methods of the present technology include a method comprising the steps of: (a) ingesting GIS data into a computer system, wherein said GIS data comprises terrain data, feature data, infrastructure data, land cover data and imagery data; (b) classifying objects in said imagery data by a machine learning (ML) model trained on computer vision; (c) prompting a text-to-image model to generate based on said GIS data, one or more geospatial objects in a georeferenced synthetic environment; (d) producing one or more visualization assets based on said GIS data, said classifying and said one or more geospatial objects; (e) generating by said computer system said georeferenced synthetic environment based on said one or more visualization assets; and (f) displaying said georeferenced synthetic environment on a computer display connected to said computer system.

The systems and apparatus of the present technology include a georeferenced synthetic environment generation system executing computer-readable instructions stored in a non-transitory storage medium and at least one microprocessor coupled to said non-transitory storage medium for executing said computer-readable instructions, said computer-readable instructions causing said at least one microprocessor to: (a) ingest GIS data into said georeferenced synthetic environment generation system, said GIS data comprising terrain data, feature data, infrastructure data, land cover data and imagery data; (b) classify objects in said imagery data by a computer vision-based machine learning (ML) model to obtain classified objects; (c) prompt a text-to-image system to generate based on said GIS data, one or more objects in a georeferenced synthetic environment; (d) produce one or more visualization assets based on said GIS data, said classified objects and said one or more objects in said georeferenced synthetic environment; (e) generate said georeferenced synthetic environment based on said one or more visualization assets; and (f) display said georeferenced synthetic environment on a computer display of said georeferenced synthetic environment generation system.

The systems and apparatus of the present technology further include a plugin for a game engine executing computer-readable instructions stored in a non-transitory storage medium and at least one microprocessor coupled to said non-transitory storage medium for executing said computer-readable instructions, said computer-readable instructions causing said at least one microprocessor to: (a) ingest GIS data comprising terrain data, feature data, infrastructure data, land cover data and imagery data; (b) classify objects in said imagery data by a computer vision-based machine learning (ML) model to obtain classified objects; (c) prompt a text-to-image system to generate based on said GIS data, one or more geospatial objects in a georeferenced synthetic environment; (d) produce one or more visualization assets based on said GIS data, said classified objects and said one or more geospatial objects; (e) generate by said game engine said georeferenced synthetic environment based on said one or more visualization assets; and (f) display said georeferenced synthetic environment on a computer display connected to said game engine.

Clearly, the systems and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 illustrates the design and architecture of a standalone georeferenced synthetic environment generation system based on the instant principles.

FIG. 2 presents the design and architecture of a georeferenced synthetic environment generation system of the present design that is implemented as a plugin to a game engine.

FIG. 3A shows a screenshot of a map of Earth with a grid from which a user can select one or more tiles to be generated by the system in the synthetic environment.

FIG. 3B shows a screenshot where a selected tile is being generated with local coordinates.

FIG. 3C-D present the screenshots of the local view generated by the system for the tile selected in FIG. 3B.

FIG. 3E shows a screenshot where a selected tile is being generated with geodetic coordinates.

FIG. 3F-G present the screenshots of the georeferenced view generated by the system for the tile selected in FIG. 3E.

FIG. 4A-E present screenshots of a synthetic environment procedurally generated for a location in the city of Las Vegas.

FIG. 4F shows a screenshot with an avatar introduced into the environment of FIG. 4A-E.

FIG. 4G presents a screenshot with the avatar of FIG. 4F performing a task.

FIG. 5A shows a screenshot of a procedurally generated 3D model of a fence around a Las Vegas street.

FIG. 5B shows a screenshot of a 3D model of a road by the fence of FIG. 5A.

FIG. 5C presents a screenshot with the 3D models of manholes in the scene of FIG. 5A-B being selected.

FIG. 5D presents a screenshot with the selected manholes of FIG. 5C deleted.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. The figures depict embodiments of the present invention for purposes of illustration only. One skilled in the art will readily recognize from the following description that alternative embodiments of the structures and methods illustrated herein may be employed without departing from the principles of the invention described herein.

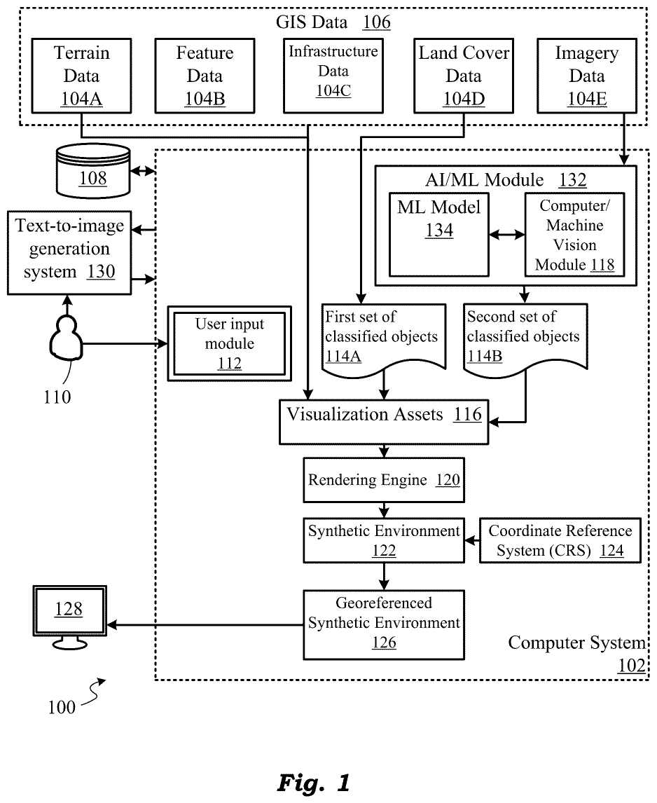

The systems and methods of the present invention will be best understood by first reviewing a georeferenced synthetic environment generation system 100 as depicted in FIG. 1. FIG. 1 shows that georeferenced synthetic environment generation system or platform 100 has a computer system 102 with its various components or modules as explained herein. It will be understood by those skilled in the art that various subsystems, modules or components of system/platform 100 may be centralized/integrated together or be distributed.

According to the chief aspects, computer system 102 ingests a variety of geographic information systems (GIS) data 106. GIS data 106 includes terrain data 104A, feature data 104B, infrastructure data 104C, land cover data 104D and imagery data 104E. In the preferred embodiment, GIS data 106 also includes cadastral data, not explicitly shown in FIG. 1. Furthermore, the present technology admits of any other type of relevant geographic information or geospatial data to be included in GIS data 106. Further, depending on the embodiment, GIS data 106 may be conceived to include any subset or all of the above types of data. The embodiment of FIG. 1 shows all of data 104A-E to be included in GIS data 106 as shown by the dotted-lined box.

There is a database 108 connected to computer system 102 that is used for storage and retrieval of GIS data 106 in accordance with the operation of system 100 as provided in this disclosure. Land cover or coverage data 104D describes the physical material present on the surface at each location, such as vegetation, water, soil, or built structures. Land cover data 104D is typically represented by raster data classified into a variety of land objects, including trees, bushes, buildings, water, snow, and the like. FIG. 1 shows that land cover data 104D is represented by a first set of classified objects 114A. Per above, these objects are stored in database 108 of computer system 102.

Furthermore, there is an instant artificial intelligence (AI) and/or machine learning (ML) module 132 that classifies the objects found in imagery data 104E. Imagery data 104E comprises satellite imagery and/or aerial imagery obtained by airplanes and/or drones. Regardless of the source, AI/ML module 132 classifies the objects in such imagery data and produces a second set of classified objects 114B as shown. In order to accomplish its objectives, AI/ML module 132 uses a classification ML model 134 that is pretrained on classifying land objects.

ML model 134 does this in conjunction with a computer/machine vision module 118 that is in charge of identifying objects in imagery data 104E. Preferably, ML model 134 is implemented using an appropriate classification model preferably including but not limited to Logistic Regression, Linear Discriminant Analysis, Quadratic Discriminant Analysis, Naïve Bayes, k-Nearest Neighbors, Decision Trees, Random Forests, Gradient Boosting Machines, XGBoost, LightGBM, CatBoost, Support Vector Machines, Multilayer Perceptrons, Convolutional Neural Networks, Recurrent Neural Networks, LSTMS, GRUS, Transformers, Graph Neural Networks, Bagging, Boosting, Stacked Ensembles, Voting Classifiers, Ridge Classifier, Lasso, Elastic Net.

Machine vision module 118 preferably utilizes open source Computer Vision Library (OpenCV™) library and/or computer software code compatible with the OpenCV library for recognizing objects in imagery data 104E. Such an implementation preferably uses non-deterministic computer vision algorithms for object identification. Regardless of the various possible implementations of model 134 and module 118, AI/ML module 132 generates a second set of classified objects 114B that are then also stored in database 108.

There is a user 110 that provides a request to generate a synthetic environment. User 110 provides such a request via a user input or user interface module 112. User input module 112 is preferably a graphical user interface (GUI) module, using which user 110 submits requests to system 102 for generating a synthetic environment. A request submitted by user 110 may take the form of a natural language request that is processed by system 100 using natural language processing (NLP) techniques. Alternatively, the request may take the form of a structured request provided textually or via GUI widgets.

Exemplary requests provided by user 110 include “Generate the selected tile or tiles on the map” or “Generate a synthetic version of the entire or selected portions of the city of Las Vegas” or “Generate an environment that resembles the current Times Square area of New York City but with 1950s-era cars”, or “Create a recent San Francisco-like city showing pedestrians in 1800s' attire on Market Street”, among others. Per above, such user requests may be provided via appropriate GUI widgets or as unstructured NLP queries.

Computer system 102 then processes the request to procedurally generate the requested synthetic environment. More specifically, computer system 102 initializes at a specific location in the world space and outputs a screen-space representation of the real world on computer display 128 of synthetic environment generation platform 100. Using the CPU, the system identifies and loads relevant terrain data 104A from database 108 corresponding to the initial location. It overlays it with feature, infrastructure and land cover data 104B-D as appropriate. It then performs the necessary transformations to construct a mesh of points. The GPU processes this mesh, applying geometric transformations to render screen-space objects (such as polygons) that visually replicate the real-world location.

Let us now review the above operation of the system in further detail. Terrain data 104A ingested by computer system 102 may be derived from Light Detection And Ranging (LiDAR) data represented as point clouds. Terrain data 104A describes the shape and elevation of any point on Earth. It is often raster-based and includes elevation data that may be represented by a digital elevation model (DEM). Additionally, terrain data 104A may also include surface data, preferably represented by a digital surface model (DSM). Terrain data answers questions such as, “How high is the ground here?”, or “What does the land surface look like at this location?”, and the like.

Feature data 104B describes discrete objects or boundaries on Earth. It is usually vector-based and describes the features on Earth by vectors. The features may be points, lines and areas/polygons. Feature data 104B represents “things” on the terrain that may be natural or man-made. Exemplary features or things include, roads, rivers, trails (as lines), towers, trees, hydrants (points) and buildings, lakes, parcels (as polygons). Depending on the embodiment, feature data 104B is preferably represented in formats including Shapefile™ (.shp+friends), GeoJSON (.geojson/.json), OpenStreetMap®, and MBTiles™, among others.

Infrastructure data 104C contains vector information about roads, highways, pedestrian walks, bridges, car parkings, and the like. These are typically expressed as linear features or lines per above. As such, depending on the embodiment, infrastructure data 104C is also preferably represented by formats including Shapefile (.shp+friends), GeoJSON (.geojson/.json), OpenStreetMap, and MBTiles, among others. Lander cover data 104D is typically raster-based and describes surfaces as discussed above, and is typically based on data obtained from satellite sources including the Sentinel-2, Maxar®, and Copernicus satellites.

Imagery data 104E is also typically raster-based and is represented in orthophoto formats preferably including GeoTIFF, COG, JP2, and MBTiles, among others. It is based on photographic data obtained from satellite and aerial (aircraft/drone) sources per above. Preferably, imagery data 104E has resolution down to 10 meters. As already noted, not explicitly shown but preferably included in GIS data 106 is cadastral data obtained from appropriate agencies, domestic or international. Cadastral data defines land ownership and property boundaries.

As a key innovation of the present technology, there is also a text-to-image generation system or simply a text-to-image system 130 that is based on a text-to-image generative AI model. System 130 processes textual prompts submitted by user 110 and/or automatically by computer system 102 for augmenting the synthetic environment being generated. More specifically, user 110 may provide a prompt to text-to-image system/model 130 to “Include a steel fence on either side of Broadway Avenue”, or “Make sure that the building at 123 Main Street has an American-style façade”, or “Include an avatar in the scene who can take textual/audio requests for providing directions to any address in the scene”, among others.

Preferably, the text-to-image system 130 is based on the OpenAI® DALL·E® text-to-image generative AI model. However, in other embodiments, the text-to-image system 130 may be based on any other appropriate image generation model, including Mistral AI™, Google Earth™ and the like. In the embodiment shown in FIG. 1, text-to-image system 130 is external to system 102. However, in alternate embodiment, text-to-image generation may be performed internally by system 102 itself based on generative AI techniques.

In any case, as a result of the above textual prompts, text-to-image system 130 obtains the correct latitude and longitude of the scene being referenced and loads the associated GIS data. In the preferred embodiment, text-to-image system 130 uses its own GIS database to load the terrain, feature, infrastructure and land cover data related to the scene. In an alternative embodiment, it loads GIS data 106 used by the rest of the rendering pipeline for augmenting the synthetic environment in accordance with the prompt.

Thus, computer system 102 processes GIS data 106, first and second set of classified objects 114A and 114B respectively as well as geospatial content produced by text-to-image system 130 in a graphics rendering pipeline. As a result, computer system 102 generates visualization assets 116. In a preferred embodiment, visualization assets 116 are files compatible with the osgEarth™ format. However, when the instant technology is implemented as a plugin as will be described further below, visualization assets are the scene objects rendered by a game engine or a simulation engine.

osgEarth is a de facto standard ecosystem built on OpenSceneGraph (OSG) for large-scale, geospatial 3D visualizations. Depending on the embodiment, visualization assets or files 116 may include:
1. earth configuration files in xml format representing map profiles, layers, coordinate reference system (CRS) and caching. Depending on the embodiment, these files may also be in JSON format.
2. Raster terrain and imagery files. osgEarth uses Geospatial Data Abstraction Library (GDAL) to read/write these files. GDAL is an open-source software library that reads, writes, and transforms geospatial data formats, both raster and vector. As understood by skilled artisans, GDAL is the universal translator £ for geospatial data formats. Preferably, raster terrain and imagery files are in the following formats:
   GeoTIFF (.tif /.tiff) for elevation and imagery
   IMG/HGT/DTED
   JPEG/PNG (often tiled via TMS/WMTS)
   MBTiles (raster tiles stored in SQLite)
   WMTS/WMS/TMS (services, not files)
   ECW®/MrSID® (if GDAL enabled)
3. Elevation models, expressed in same or similar container types as imagery data, e.g.:
   GeoTIFF DEM/DTM/DSM
   SRTM .hgt files
   ArcGrid
   MBTiles elevation tile pyramids (in some workflows)
4. Feature data represented by vectors supported via GDAL/OGR.
   Shapefile (.shp+.dbf+.shx+.prj)
   GeoJSON (.geojson)
   OSM format (.osm/.pbf)
   KML/KMZ
   GeoPackage™ (GPKG)
   WFS (Web Feature Service)
5. Rendering-side formats supported by OpenSceneGraph:
   .osg (text scene graph)
   .osgb (binary optimized)
   .ive (older binary)
   Custom geometry, shaders, etc.

Preferably, visualization assets 116 also include files for caching and/or other runtime optimizations. These include:
.mxl—tile cache files (internal binary)
.osgb, .osgt—OSG scene graph cache artifacts
Directory pyramids for imagery/elevation tiles

Visualization assets 116 described above are then processed by a rendering engine 120 of computer system 102 in order to render synthetic environment 122. In the preferred embodiment, rendering engine 120 is OpenSceneGraph or compatible with it. In one embodiment, the synthetic environment that is ultimately desired is in local coordinates only or is a just a local view, and is thus not georeferenced. In such an embodiment, synthetic environment 122 is directly displayed on computer display 128 of computer system 102 in real-time or near real-time.

However, in the preferred embodiment shown in FIG. 1, a coordinate reference system (CRS) is applied to the local coordinates of synthetic environment 122 in order to place them on Earth. As a result, we obtain georeferenced synthetic environment 126 that is then ultimately presented on computer display 128 in real-time or near real-time. Oftentimes in practice, CRS 124 is provided as an initial input to rendering engine 120 so that it generates georeferenced synthetic environment 126 in a single step.

In any event, the preferred embodiment uses geodetic coordinates based on World Geodetic System 1984 (WGS 84) geodetic coordinate system for georeferencing synthetic environment 126. WGS 84 is a georeferenced model based on latitude, longitude and height above sea-level. However, alternative embodiments may use any other valid CRS. Thus, computer system 102 procedurally generates synthetic environment 122 or georeferenced synthetic environment 126 in response to user request submitted by user 110 via user input module 112.

Computer system 102 accomplishes the above based on GIS data 106, classified objects 114A-B and geospatial objects generated by text-to-image generation system 130 based on prompts submitted by user 110 and/or computer system 102 itself. As discussed above, classified objects 114 include a first set of classified objects 114A already contained in land cover/coverage data 104D. It also includes a second set of classified objects 114B classified by instant AI/ML module 132. Module 132 employs an appropriate classification ML model 134 pretrained on classifying land objects based on computer/machine vision implemented by computer or machine vision module 118.

Now, instead of or in addition to displaying synthetic environments 122/126 on display 128, synthetic environments 122/126 may also be exported for integration with external systems. Such systems may be simulation systems, game engines or other 3D geospatial visualization systems. Exemplary game engines include Unity® and Unreal Engine®. Exemplary simulation systems include Gazebo, CARLA, and Microsoft® AirSim, among others. Depending on the embodiment, there are several possibilities for the export/exchange format of files for integration with external systems. The most common exchange formats for game engines include glTF™/GLB, FBX®, and OBJ for models and scene geometry, with glTF/GLB becoming the modern favorite and FBX widely used for compatibility.

Terrain often exports as heightmaps (PNG/TIFF) or tiled meshes, and can originate from DEM/GeoTIFF but usually requires conversion first. Simulation stacks additionally use domain formats such as OpenDRIVE (.xodr) for road networks and OpenSCENARIO (.xosc) for traffic and behavioral logic, while Gazebo uses SDF (.sdf) with meshes in DAE/OBJ/GLTF. GIS formats like Shapefile, GeoJSON, OSM/PBF, and MBTiles serve as inputs and must be processed into meshes, splines, or textures before import.

Georeferenced synthetic environment generation system 100 of FIG. 1 of the present technology described above is a standalone platform/system. In other words, platform/system 100 along with its computer system 102 incorporate all the data and computer modules for the generation of final synthetic environments 122/126.

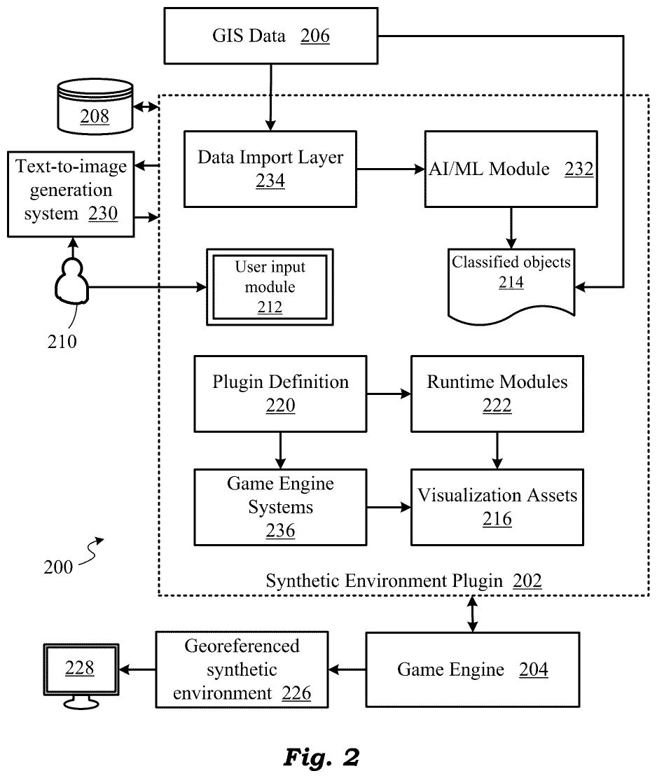

However, in a highly preferred embodiment, the present technology is implemented as a plugin to a game engine. Now, let us take advantage of FIG. 2 to understand such a preferred embodiment in greater detail. FIG. 2 shows a georeferenced synthetic environment generation system/platform 200 of the instant design that contains a georeferenced synthetic environment generation plugin 202 integrated with a game engine 204. Preferably, game engine 204 is an Unreal Engine, however the present principles admit of other game engines or simulation engines onto which plugin 202 may be implemented.

There is GIS Data 206 analogous to GIS data 106 of standalone system 100 of the above teachings. A data import layer 234 of the instant plugin is responsible for importing the various types of GIS data 206 into plugin 202 for downstream processing. There is also a database 208 analogously to database 108 for the storage and retrieval of GIS data 206 as well as for the storage retrieval of other data/files required for the operation of plugin 202. While some land objects in GIS data 206 may already be classified, there is also an AI/ML Module 232 analogously to AI/ML module 132 of system/platform 100 of the prior teachings.

AI/ML module 132 is responsible for further classifying GIS objects based on a classification model. The classification model is trained using computer vision techniques preferably applied on hyperspectral satellite images provided by European Space Agency (ESA) produced within the previous year. In the preferred embodiment, AI/ML module 232 classifies non-terrain objects into 9 different classes. These include bare ground, rivers or water bodies, vegetation or bush or shrub that is 5 meter above ground, grass, snow, ice, sand as well as man-made objects such as roads, runways, buildings, among others. Whether imported directly or classified by AI/ML module 232, we thus obtain classified objects 214 as shown.

According to the chief aspects, there is a plugin definition module 220 of plugin 202 that is the entry point for game engine 204 describing what the plugin is and how it loads. Preferably, the plugin definition consists of a .uplugin file and module startup/shutdown classes that register the plugin code with game engine 204. There are also runtime modules 222 containing the functional code that executes inside game engine 204 during the operation of the system. These modules create and manage systems, actors, components, and data structures that participate in the synthesized or synthetic world by interacting with the APIs of game engine 204.

There are further game engine systems 236 typically provided by game engine 204 for rendering, asset management, physics, animation, AI, and input processing. Analogously to visualization assets 116, visualization assets 216 are the scene objects or entities created by plugin 202 native to game engine 204. Preferably, these include meshes, landscapes, components, path networks, and actors. They populate the synthetic world and become part of the scene graph of game engine 204. These are directly available or instantiable in game engine 204 via the interface/APIs of the engine.

As in the prior embodiments of FIG. 1, there is a text-to-image generation system 230 analogous to system 130. User 210 can provide textual prompts to text-to-image system 230 or such prompts can be provided by plugin 202 itself. In response to the prompts, and per prior teachings, text-to-image system 230 generates content/objects that is/are augmented or overlaid onto the synthetic environment produced by the plugin modules. Based on the above functionality, georeferenced synthetic environment plugin 202 of the instant design in conjunction with game engine 204 generates a synthetic environment 226 that is displayed in real-time or near real-time on display 228 of game engine 204. Preferably, synthetic environment 226 is georeferenced, however that is not a required of the design.

In the manner taught above, the present technology can be implemented in a standalone manner as described in reference to synthetic environment generation system 100 along with its computer system 102 of FIG. 1. Alternatively, the present technology can also be implemented as a plugin as described in reference to synthetic environment generation system 200 with its plugin 202 to game engine 204 of FIG. 2.

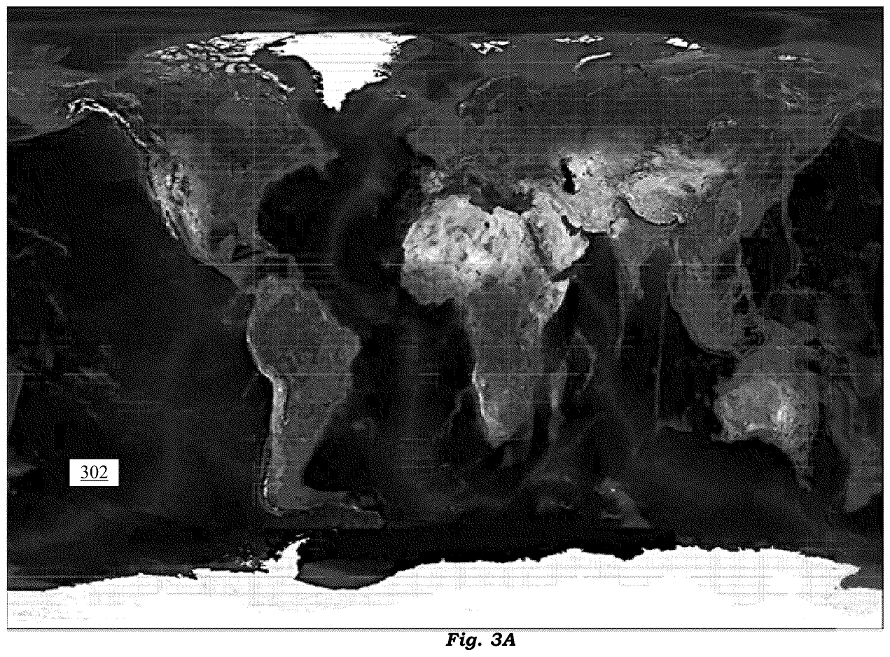

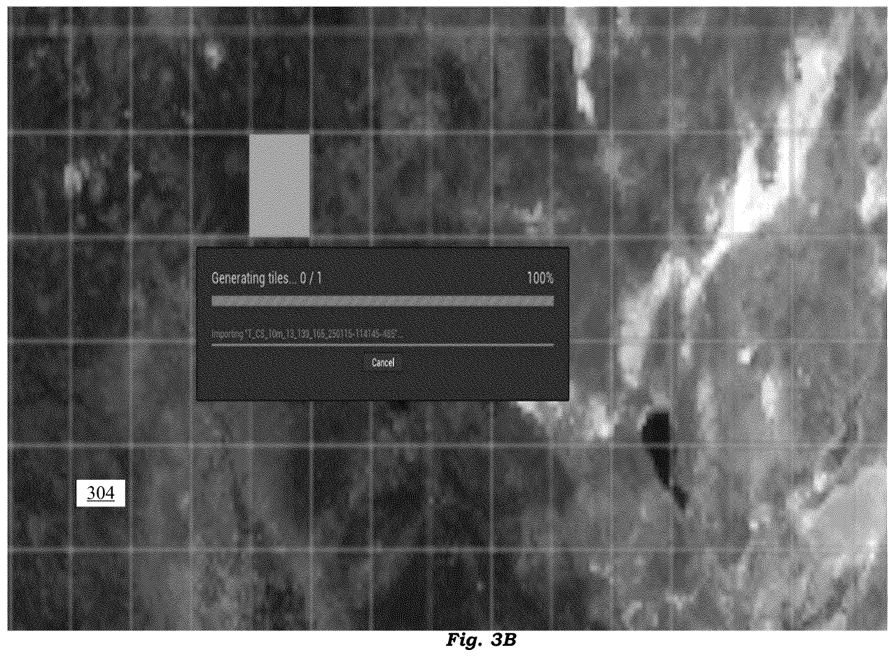

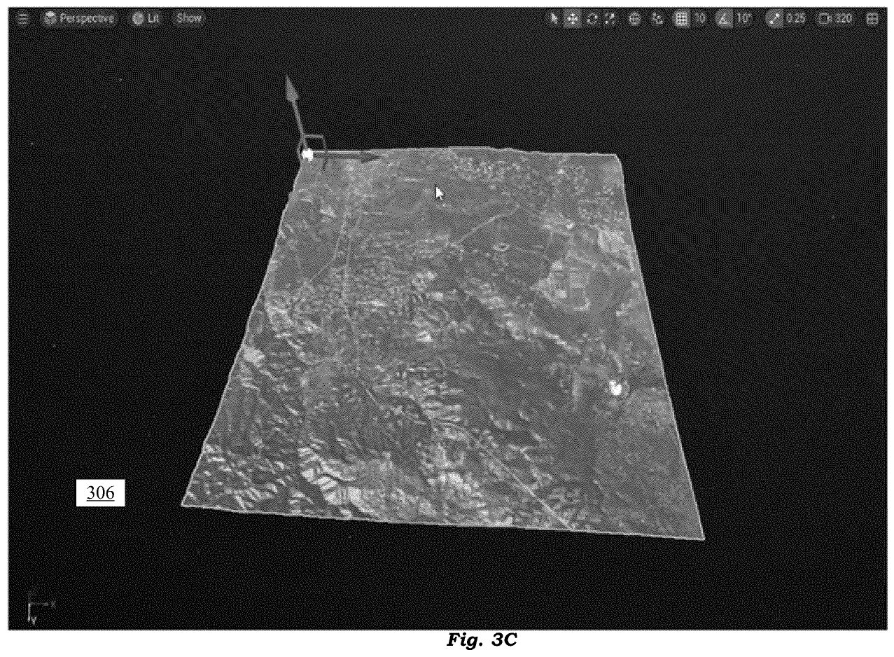

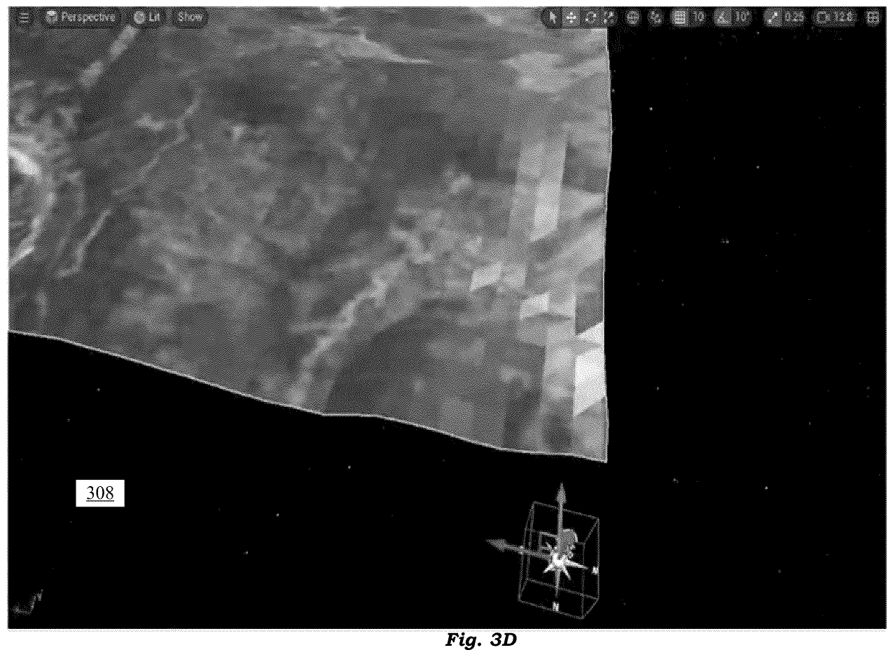

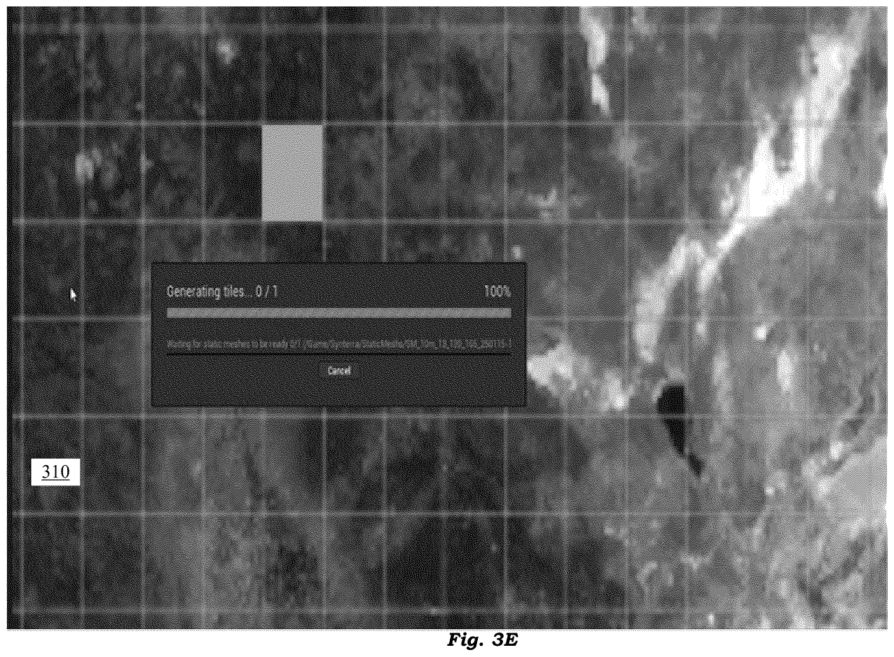

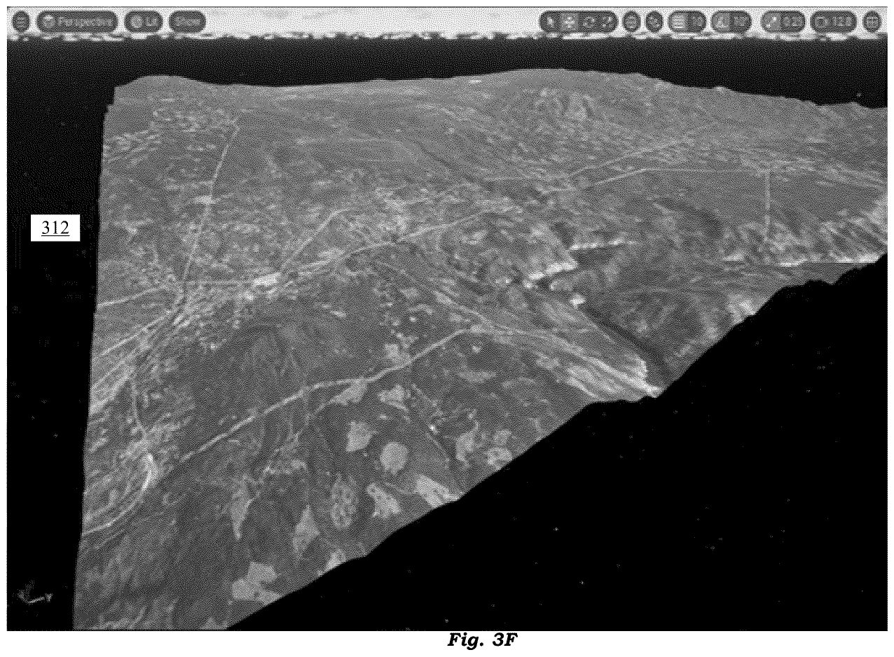

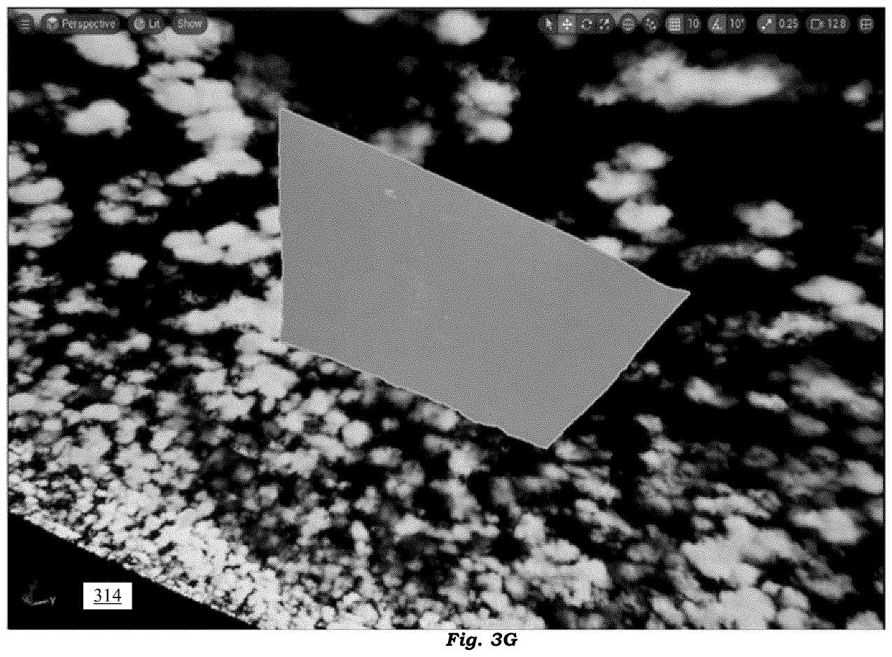

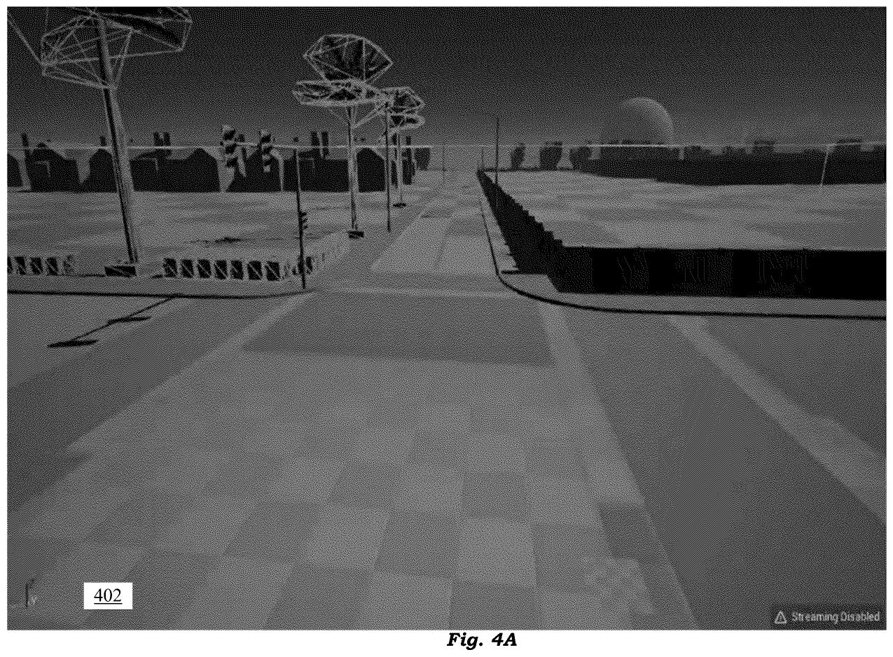

Now, let us take a look at an exemplary implementation of system 200 and plugin 202 in which game engine 204 is Unreal Engine® version 5.5 from Epic Games, Inc. or UE for short. For this purpose, let us take a look at the screenshots of FIG. 3-5 generated using such an implementation.

The instant plugin is referred to as synterra in this implementation and database 208 is implemented as a cloud storage. In the preferred variation, the cloud storage resource is Amazon AWS™ S3 bucket. Further, text-to-image system 230 is preferably implemented using OpenAI's application programming interface (API), and more specifically by accessing ChatGPT® chatbox to interface with one or more of text-to-image (DALL-E) models of OpenAI.

While still referring to FIG. 2, S3 storage-based database 208 stores GIS data 206 as an instant global database for the whole earth. Since this data is large, it is impractical to store it locally on client machines. In the preferred implementation, this S3 bucket is named synterra and has read-only permissions. There is another S3 bucket named synplanet with read-write permissions where user 210 can upload their own data. Exemplary user data that may be uploaded to synplanet S3 bucket includes visualization of a new building at a construction site that a construction company uploads to the synplanet S3 bucket via the Unreal Engine, or visualization of a new landmark or feature at a given location, among others.

synterra bucket in database 208 also holds classified objects 214 as well as elevations of the objects preferably based on WGS 84 geodetic coordinate system and more specifically relative to a vertical datum such as WGS 84 or NAVD88. Instant plugin 202 does not take a lot of storage space, only on the order of 20-25 Megabytes in the present implementation.

Now, let us review the screenshots of FIG. 3-5 produced using the present implementation. After initialization, instant plugin 202 first displays a world map 302 with a grid as shown in FIG. 3A. User 210 can zoom in or zoom out on the map using familiar navigation methods. Using ray casting methodology, user 210 can then select one or more tiles of interest on the world map, preferably by pressing the left mouse button. The selected tile is depicted in screenshot 304 of FIG. 3B.

The selection of the tile to be generated by user 210 may be done via GUI as shown in FIG. 3B. Alternatively, it may be performed using a natural language request by user 210 via user input module 212 shown in FIG. 2 analogously to user input module 112 of FIG. 1. More specifically, user 210 may provide a request such as “Generate the tile covering these latitudes and longitudes: [−122.55°, 37.70°, −122.35°, 37.85°]”.

In the preferred implementation, each tile on the grid shown in FIG. 3A-B represents an area of 30 square kilometers on earth, however that number is configurable. Furthermore, while the instant principles place no limit on the number of tiles that may be selected, in the preferred implementation, the maximum number of tiles selected is 3, so as not to overwhelm the backend storage system i.e. Amazon AWS S3 of database 208.

The instant design provides an easy to use “one button solution”. What this means is that user 210 can press one button to procedurally generate a synthetic environment/terrain/content 226 for the selected tile. Plugin 202 is able to do so efficiently because the size of the information generated for the tile is of the order of only 20 Mbytes in the preferred implementation. This is accomplished by virtue of innovative storage techniques employed by the present technology. More specifically, plugin 202 is able to efficiently generate synthetic environment 226 by performing the processing on the backend and by sending only the latest version of the generated terrain/content to UE game engine 204. UE 204 then includes this latest content in the synthetic environment 226 for displaying on display 228.

As a result, plugin 202 is promptly able to generate the data for the selected tile. Screenshot 304 of FIG. 3B shows the local view of the selected tile being generated. The generated tile is shown in the local views of screenshots 306 and 308 of FIG. 3C and FIG. 3D respectively. The filename of the Actor object of UE generated by the system is encoded with useful information. In one example, the Actor mesh is named as SM_10m_13_130_181_250115-113533-845. The components of this filename are as follows:
SM=SynTerra Module
10m=10-meter resolution
13=level of terrain i.e. 30×30 kilometer tiles on the grid as shown in FIG. 3A. The higher this number, the smaller the size of the tile on the grid. In another embodiment, the size of the tile is configurable by user 210.
139, 165=last 3 degrees of the latitude and longitude of the tile expressed in decimal degrees.
250115=date
113533=local time

The coordinate system of the local views of FIG. 3C-D is local and provides ease of local navigation. The locations in the local view are not georeferenced. In an exemplary embodiment, the local coordinate system is based on imagining the bottom left corner of the generated terrain/tile at the origin at the center of the earth.

The geodetic view is where the locations are georeferenced to Earth. It should be noted that the geodetic and local views are equivalent but offer different views of the same underlying generated terrain. The geodetic view is relative to the entire Earth and its locations are georeferenced. Typically, the local view is well suited for performing presentations and for developing video games while the geodetic view is well suited for professional applications such as flight simulations, training of self-driving/autonomous vehicles in the auto industry, and the like.

Let us now review the geodetic view of the same tile for which the local view was presented in FIG. 3C-D. Screenshot 310 of FIG. 3E shows the geodetic view of the selected tile being generated. Screenshots 312 and 314 41 FIG. 3F and FIG. 3G respectively provide the geodetic views of the tile.

Exemplary user(s) 210 of the present technology include game developers, film/video editors, live event producers, automotive industry users, manufacturing industries' users, simulation developers among others. Based on the present technology, these users can generate artificial/synthetic terrain for various locations on Earth automatically, procedurally and efficiently. In the techniques of the prior art, this is a manual process and takes a lot of time and resources. For example, generating a synthetic version of New York City manually could take a year or two. The present technology dramatically improves upon such techniques as provided herein.

With instant global database 208 of the whole Earth shown in FIG. 2, user 210 is able to procedurally generate terrain for any location on Earth on demand and without resorting to manual processes of the prior art. As noted above, plugin 202 also interfaces with text-to-image system 230, preferably based on OpenAI AI models, to dramatically improve the fidelity of the generated terrain and is thus able to generate synthetic environments georeferenced to any location on Earth with high fidelity.

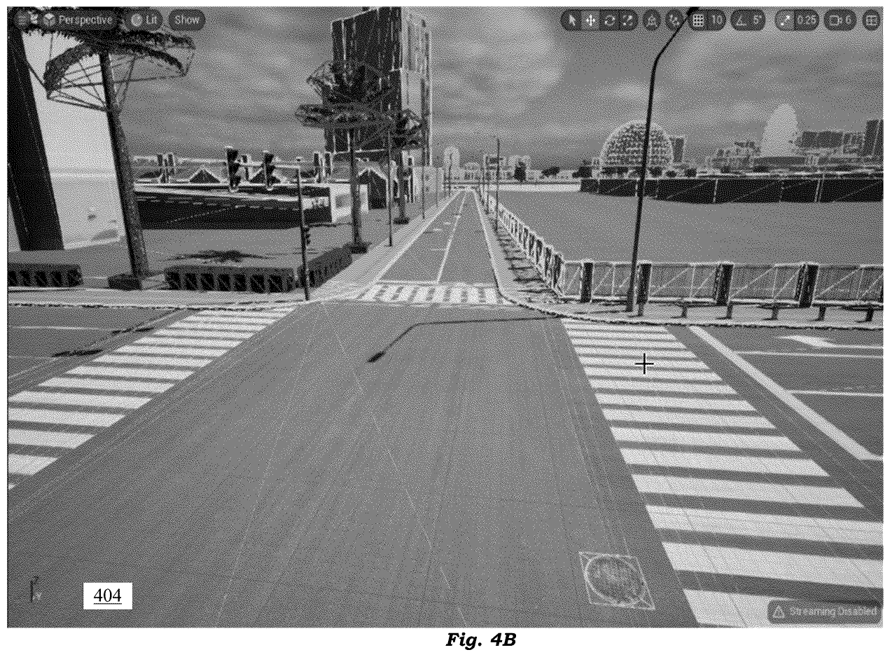

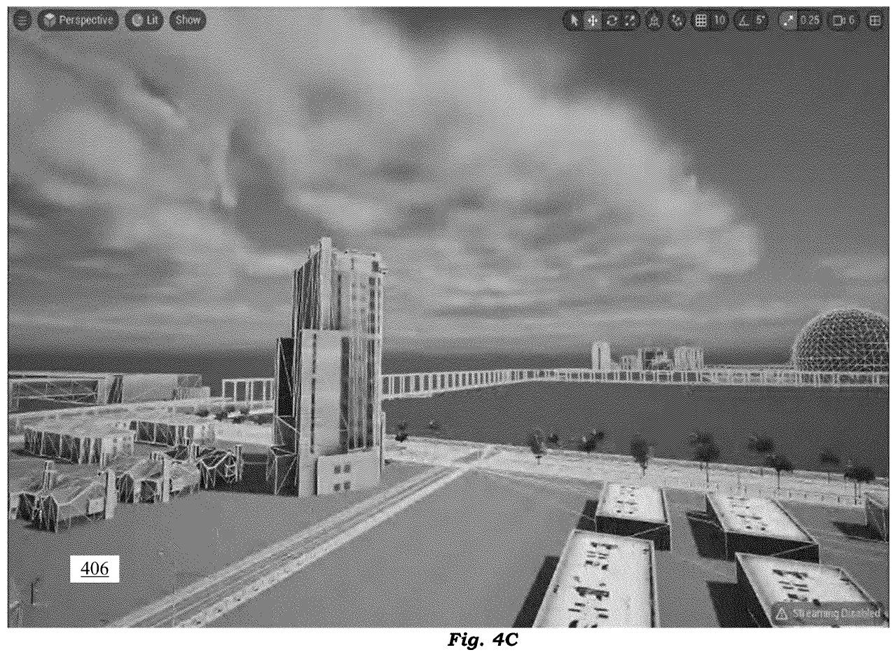

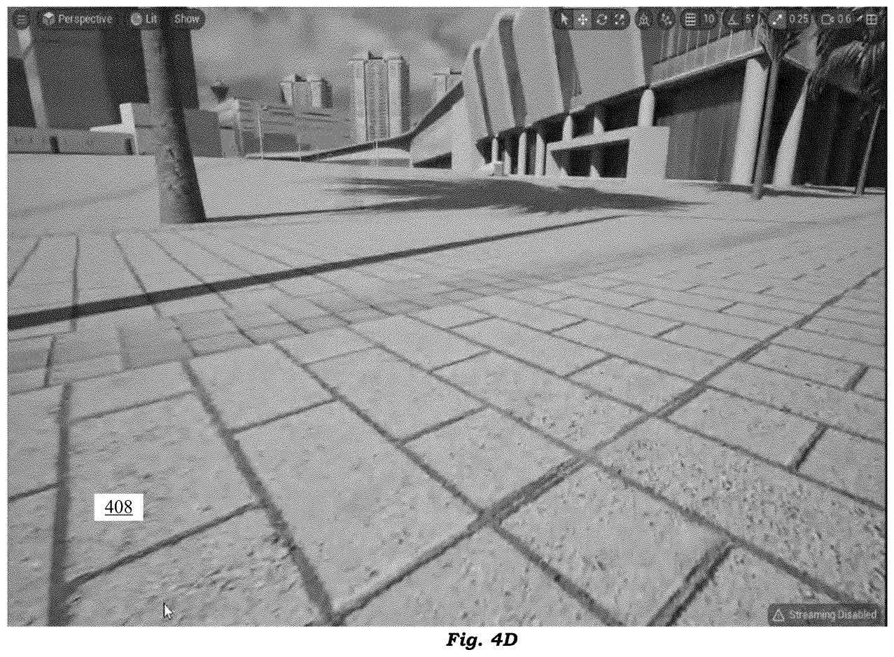

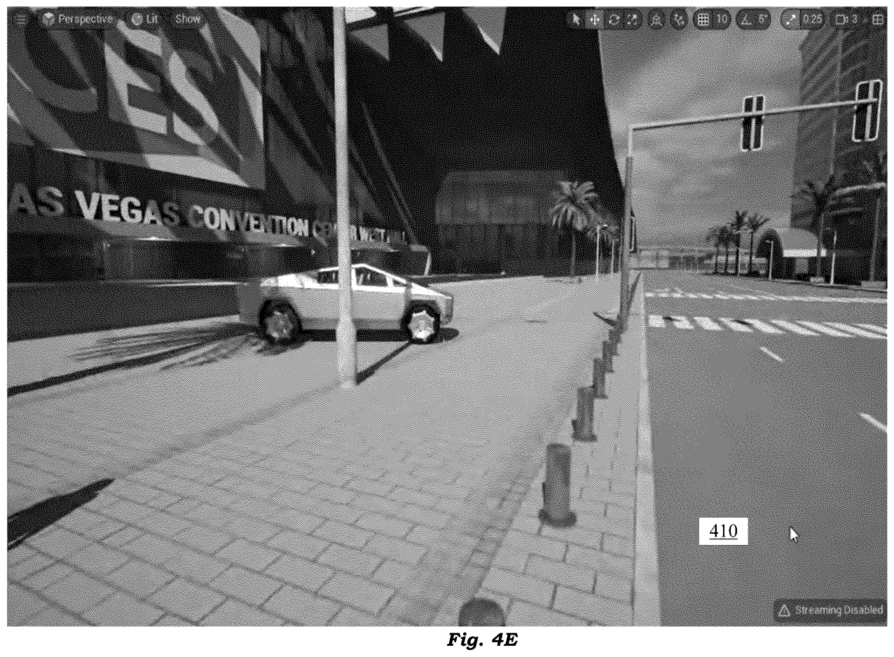

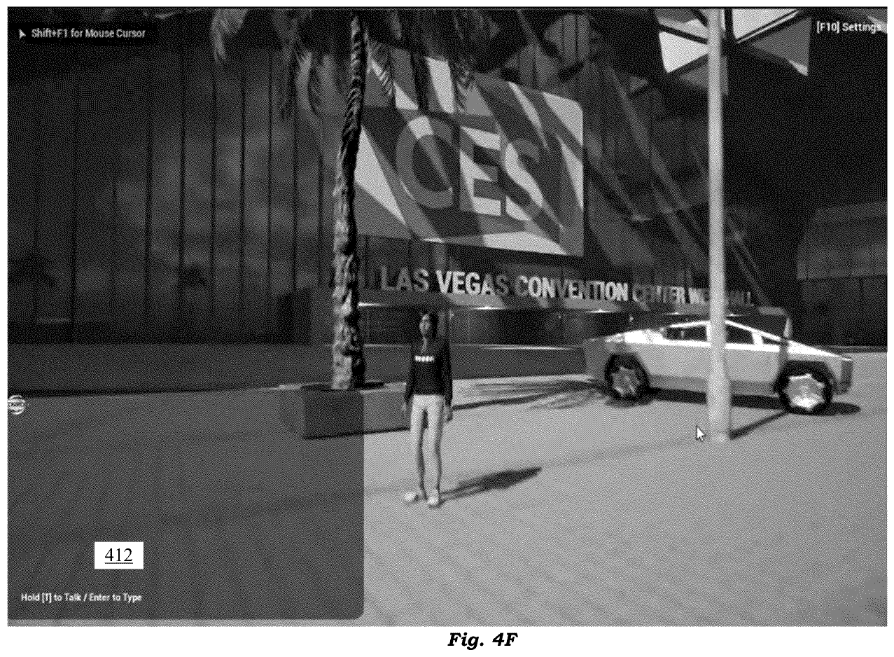

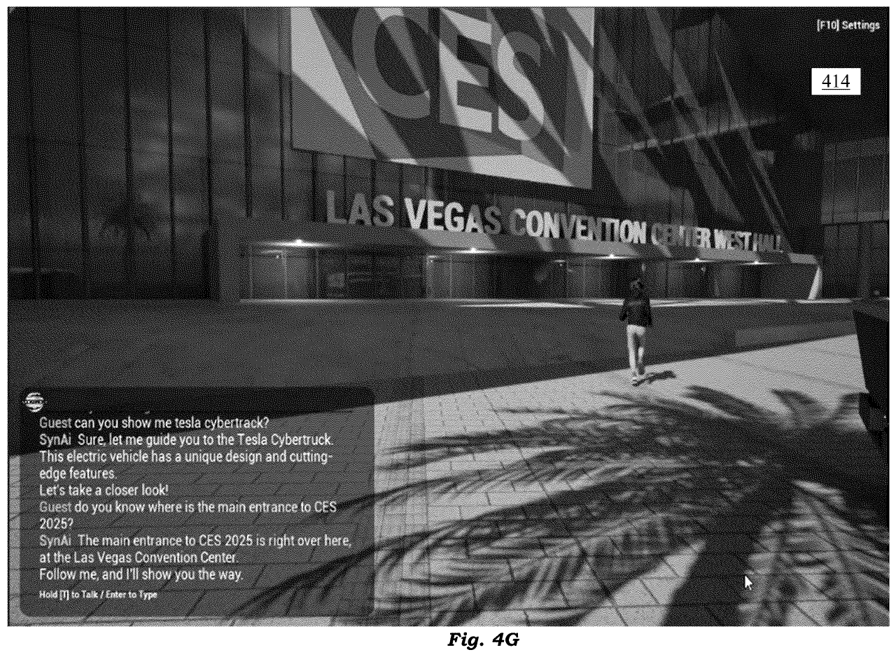

Based on the instant capability, one is able to generate synthetic version of the city of Las Vegas in half a day! This example is shown in screenshots 402, 404, 406, 408, 410, 412 and 414 of FIG. 4A, FIG. 4B, FIG. 4C, FIG. 4D, FIG. 4E, FIG. 4F and FIG. 4G respectively. The accuracy obtained by the present design is much higher than other tools such as a Google Earth™. The instant resolution can be increased to any level as desired. Let us take the exemplary screenshot 408 of FIG. 4D showing the resolution at the ground level. This is in stark contrast to what Google Earth can show at the ground level in a city. In the preferred embodiment, the rendered resolution is 15-millimeter anywhere on the globe and it is in turn based on the 10-meter resolution elevation model mentioned above. However, the above resolution can be increased to any level as desired for a given implementation.

A highly preferred embodiment of the present design uses an Avatar as shown in FIG. 4F which is based on a chatbot, preferably OpenAI's ChatGPT. Now, user 210 can ask various questions of the Avatar, for example, “Where is the nearest Tesla®?”, or “Where is the main entrance to the CES 2025 show?” or “Where is the nearest hotel?”. The avatar answers the above questions by in turning posing appropriate queries to ChatGPT. Thus, in response, the avatar goes to the requested location or object in the scene in real-time. FIG. 4G shows the avatar running to the entrance of the Consumer Electronics Show (CES) 2025 to indicate its location in Las Vegas. Any other objects or features, including cars, etc. can be placed in the synthetic environment of FIG. 4.

As other exemplary use-cases of text-to-image system 230 of FIG. 2, user 210 and/or plugin 202 asks text-to-image system 230 requests, such as: “Draw me the road or any other features at a given location”, or “Show me buildings with American-style facades at a given location” or “Draw me fences in use in New York City, along with respective latitudes and longitudes”. The text-to-image system then uses the underlying text-to-image model, e.g. DALL-E to visualize the responses based on the above textual description and based on its knowledge of the landscape.

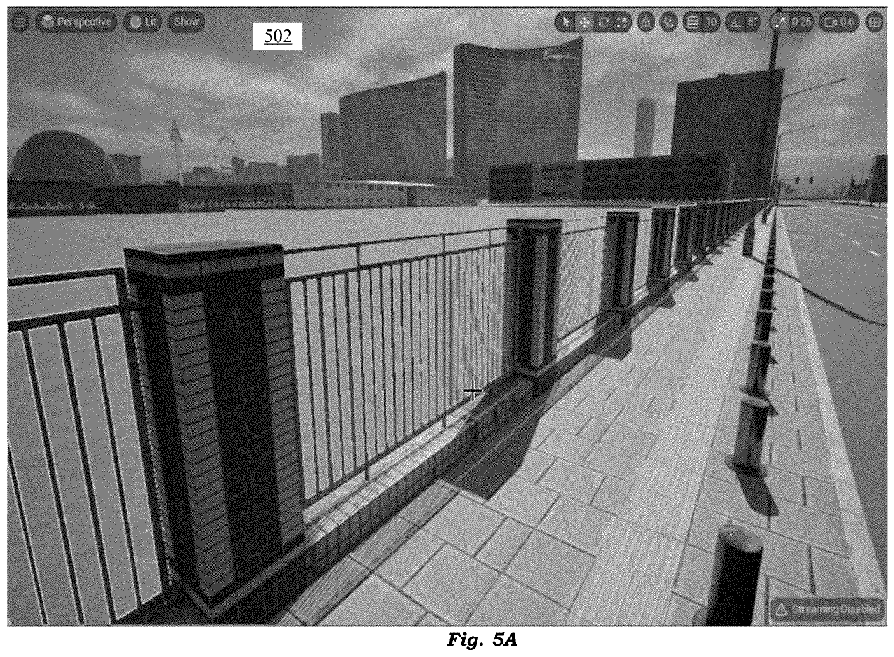

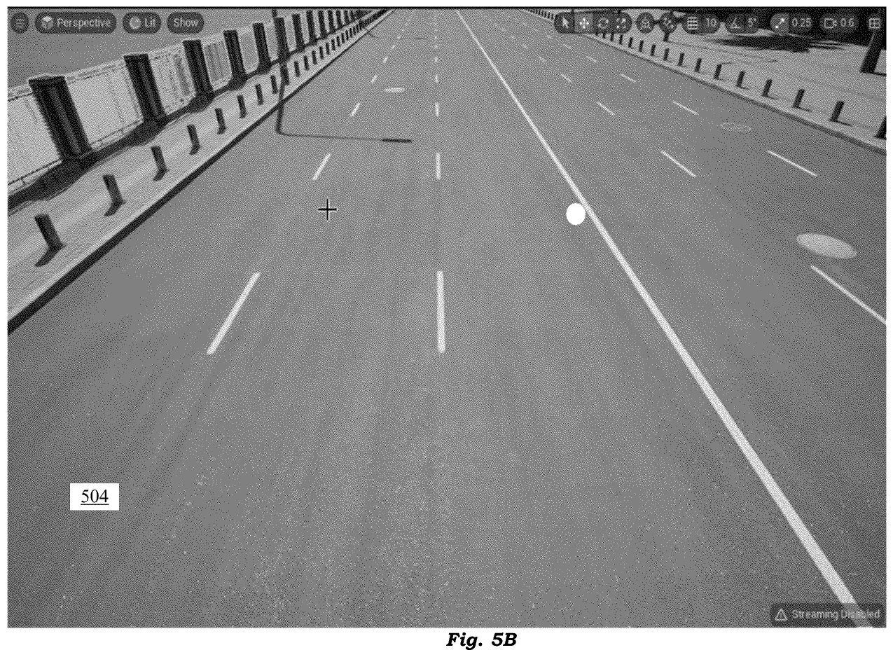

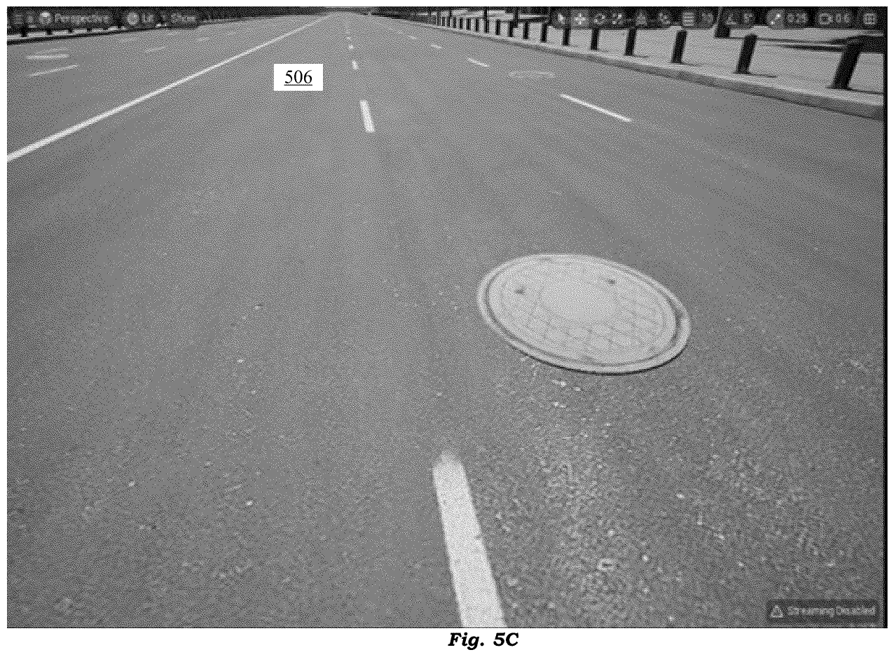

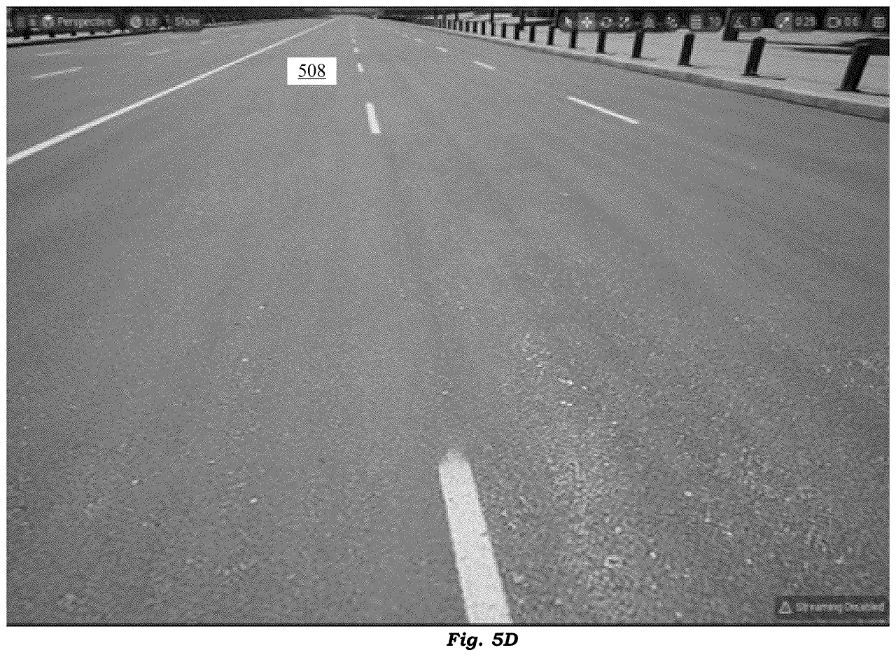

By obtaining responses to such questions, the system is able to semantically create a library of 3D models for each location. It then superposes or overlays these 3D models over the objects in the scene. FIG. 5A shows screenshot 502 of a procedurally or automatically generated 3D model of a fence around a Las Vegas street. FIG. 5B shows screenshot 504 of a 3D model of the road by the above fence. While referring to FIG. 2 in conjunction with FIG. 4, plugin 202 first queries global database 208 stored in AWS S3 to understand that there is a road at the given latitude, longitude in Las Vegas.

Per above, database 208 contains the satellite imagery, elevation data and classification data associated with the various objects. The classification data may be contained in GIS data 206 ingested by plugin 202 or determined later based on AI and computer vision techniques deployed by AI/ML module 232. Backend database 208 also contains cadastral data obtained from the applicable US (or other) agencies. For example, based on the cadastral data, plugin 202 is able to determine the number of lanes based on image resolution (10-meter) and the number of pixels utilized to render the road. The system is also preferably able to estimate the direction of the traffic.

As noted above, plugin 202 also interfaces with text-to-image system 230 to increase the fidelity of the terrain information. More specifically, in the case of a road, it preferably obtains the exact road texture i.e. plugin 202 asks text-to-image system 230 to draw the road at the location and the underlying text-to-image model would know the correct texture of the road in Las Vegas. In other words, the road in Las Vegas would have texture distinct from a road in Australia. As a result, the instant system is able to place the 3D model of the generated road on that specific georeferenced location in Las Vegas as shown in FIG. 5B.

Similarly, by interfacing with its global database 208, plugin 202 is able to determine that there is a building at a given latitude, longitude. However, it can increase the fidelity of this information by querying text-to-image system 230 to determine what type of facade the building has. It can then ask text-to-image system 230 to generate the building with the correct facade, dimensions, windows, etc. and other features.

Now it is possible that the actual road in Las Vegas does not have the manholes shown screenshot 506 of FIG. 5C. Accordingly, user 210 can simply edit the scene by removing the 3D models of the manholes by selecting the objects in the scene as shown in screenshot 506, and deleting them. FIG. 5D shows screenshot 508 of the scene with the manholes edited out.

Depending on the embodiment, there are several methods for texturing terrain surfaces that may be utilized. Some embodiments use artificial textures, such as elevation-based coloring, checkerboard patterns, or other generic designs. The present technology closely replicates real-world surfaces by utilizing aerial photography or satellite imagery for a more accurate representation, in cooperation with AI-generated objects and textures from specific locations.

The present design saves the data hierarchy in the graphics processing unit (GPU), rather than on a hard drive or solid-state drive (SSD). The generated content based on the present technology is of a much higher quality than possible using the techniques of the prior art. The present technology eliminates the need to manually create a library of building architectures, vegetation systems and other objects on the terrain. The instant technology is scalable regardless of the location of the urban and non-urban environments.

In view of the above teachings, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A method comprising the steps of:
(a) ingesting GIS data into a computer system, wherein said GIS data comprises terrain data, feature data, infrastructure data, land cover data and imagery data;
(b) classifying objects in said imagery data by a machine learning (ML) model trained on computer vision;
(c) prompting a text-to-image model to generate based on said GIS data, one or more geospatial objects in a georeferenced synthetic environment;
(d) producing one or more visualization assets based on said GIS data, said classifying and said one or more geospatial objects;
(e) generating by said computer system said georeferenced synthetic environment based on said one or more visualization assets; and
(f) displaying said georeferenced synthetic environment on a computer display connected to said computer system.

2. The method of claim 1, wherein said computer system is implemented as a plugin to a game engine.

3. The method of claim 1, wherein said georeferenced synthetic environment corresponds to a tile selected by a user on a grid displayed by said computer system on said computer display.

4. The method of claim 1, wherein said computer vision is implemented using computer software code compatible with the Open Source Computer Vision (OpenCV™) library.

5. The method of claim 1, wherein said text-to-image model is used to generate an avatar in said georeferenced synthetic environment.

6. The method of claim 1, wherein said terrain data comprises elevation data, surface data and Light Detection And Ranging (LiDAR) data.

7. The method of claim 6, wherein said elevation data has a resolution of 10 or more meters.

8. The method of claim 1, wherein said imagery data comprises satellite imagery data and aerial imagery data.

9. The method of claim 1, wherein said GIS data also contains cadastral data.

10. The method of claim 1, wherein said one or more visualization assets are compatible with the osgEarth™ format.

11. A georeferenced synthetic environment generation system executing computer-readable instructions stored in a non- transitory storage medium and at least one microprocessor coupled to said non-transitory storage medium for executing said computer-readable instructions, said computer-readable instructions causing said at least one microprocessor to:
(a) ingest GIS data into synthetic environment generation system, said GIS data comprising terrain data, feature data, infrastructure data, land cover data and imagery data;
(b) classify objects in said imagery data by a computer vision-based machine learning (ML) model to obtain classified objects;
(c) prompt a text-to-image system to generate based on said GIS data, one or more objects in a georeferenced synthetic environment;
(d) produce one or more visualization assets based on said GIS data, said classified objects and said one or more objects in said georeferenced synthetic environment;
(e) generate said georeferenced synthetic environment based on said one or more visualization assets; and
(f) display said georeferenced synthetic environment on a computer display of said georeferenced synthetic environment generation system.

12. A plugin for a game engine executing computer-readable instructions stored in a non-transitory storage medium and at least one microprocessor coupled to said non-transitory storage medium for executing said computer-readable instructions, said computer-readable instructions causing said at least one microprocessor to:
(a) ingest GIS data comprising terrain data, feature data, infrastructure data, land cover data and imagery data;
(b) classify objects in said imagery data by a computer vision-based machine learning (ML) model to obtain classified objects;
(c) prompt a text-to-image system to generate based on said GIS data, one or more geospatial objects in a georeferenced synthetic environment;
(d) produce one or more visualization assets based on said GIS data, said classified objects and said one or more geospatial objects;
(e) generate by said game engine said georeferenced synthetic environment based on said one or more visualization assets; and
(f) display said georeferenced synthetic environment on a computer display connected to said game engine.

13. The plugin of claim 12, wherein said georeferenced synthetic environment is generated in response to a natural language request submitted by a user.

14. The plugin of claim 12, wherein said computer vision is implemented using computer software code compatible with the Open Source Computer Vision (OpenCV™) library.

15. The plugin of claim 12, wherein said text-to-image model is used to generate an avatar in said georeferenced synthetic environment.

16. The plugin of claim 12, wherein said terrain data comprises elevation data, surface data and Light Detection And Ranging (LiDAR) data.

17. The plugin of claim 16, wherein said elevation data has a resolution of 10 or more meters.

18. The plugin of claim 12, wherein said imagery data comprises satellite imagery data and aerial imagery data.

19. The plugin of claim 12, wherein said GIS data also contains cadastral data.

20. The plugin of claim 12, wherein said one or more visualization assets are compatible with the osgEarth™ format.
